(19) United States
(12) Patent Application Publication
(10) Pub. No.: US 2007/0047037 A1
(43) Pub. Date: Mar. 1, 2007

(54) Hologram recording medium and hologram recording method

(75) Inventors: Hisae Yoshizawa, Ashigarakami-gun (JP); Katsunori Kawano, Ashigarakami-gun (JP); Shin Yasuda, Ashigarakami-gun (JP); Jiro Minabe, Ashigarakami-gun (JP); Yasuhiro Ogasawara, Ashigarakami-gun (JP); Kazuhiro Hayashi, Ashigarakami-gun (JP); Koichi Haga, Ashigarakami-gun (JP); Makoto Furuki, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/349,211

(22) Filed: Feb. 8, 2006

(30) Foreign Application Priority Data
Aug. 26, 2005 (JP) 2005-246690

(51) Int. Cl. G03H 1/02

(52) U.S. Cl. 359/3; 359/2

(57) ABSTRACT

A hologram recording medium including: a recording layer on which a hologram can be record as a diffraction grating by inducing a change in a refraction factor according to the light intensity distribution of writing light due to irradiation with the writing light; a reflection layer that reflects, on the recording layer side thereof, diffracted light diffracted by the hologram recorded on the recording layer due to irradiation with reading light having a wavelength different from that of the writing light; and an absorption layer that absorbs the writing light transmitted through the recording layer.

### CROSS-REFERENCE TO RELATED APPLICATION

This application claims priority under 35 USC 119 from Japanese Patent Application No. 2005-246690, the disclosure of which is incorporated by reference herein.

### BACKGROUND OF THE INVENTION

1. Field of the Invention

The present invention relates to a hologram recording medium and hologram recording method. More specifically, the invention relates to a hologram recording medium having a recording layer and a reflection layer and a hologram recording method of irradiating the hologram recording medium with a signal light and a reference light to record a transmission-type hologram.

2. Description of the Related Art

In the related art, a large amount of hologram seals duplicated from an original are stuck on plastic cards such as credit cards for the purpose of forgery prevention and authentication. The present applicant has developed a plastic card equipped with a hologram memory to strengthen an identification (ID) function and a security function. See, for example, http://www.fujixerox.co.jp/research/category/inbt/m photonics/docs/holoca.pdf Different holograms can be individually recorded onto the hologram memory. That is, arbitrary information can be written on each card on demand.

The hologram memory mounted on the plastic card is preferably a hologram recording medium formed with a recording layer on a reflection layer. The hologram recording medium irradiated with a signal light and a reference light from the same side to record a transmission-type hologram. The provision of the reflection layer can realize a memory function and high design properties at the same time.

An unnecessary diffraction grating may be written on the hologram recording medium having the reflection layer due to reflection of writing light. The unnecessary diffraction grating lowers the diffraction efficiency of the transmission-type hologram in which the signal light has been recorded.

Upon irradiation with the signal light and the reference light as the writing light at recording, the writing light transmitted through the recording layer is reflected on the reflection layer and is then incident on the recording layer again. Interference between the reflected light and the writing light may write an unnecessary diffraction grating (reflection-type hologram) on the hologram recording medium. Interference of the reflected lights of the signal light and the reference light can also write an unnecessary diffraction grating (transmission-type hologram) on the hologram recording medium. Diffracted light caused by these unnecessary diffraction gratings cancels the originally intended diffracted light to lower the diffraction efficiency of the transmission-type hologram in which the signal light has been recorded.

The transmission-type hologram in which the signal light has been recorded is a grating in the thickness direction of the recording layer. The unnecessary reflection-type hologram has a component in parallel with the thickness of the recording layer. When a photopolymer having large volumetric shrinkage is used as a recording material, the grating pitch is changed by the influence of shrinkage of the recording layer (reduction in the thickness of the recording layer) caused at recording to vary the phase of the diffracted light, and thus, the diffraction efficiency is lowered significantly.

To prevent writing of an unnecessary diffraction grating, a method in which a circularly polarized light which does not cause interference with reflected light is used as the writing light is proposed (Japanese Patent Application Laid-Open (JP-A) No.2004-185707). According to this method, interference is not caused between the reflected light and the writing light, and writing of a reflection-type hologram is prevented. However, when the circularly polarized light is used as the writing light, interference between reflected light still occurs, and writing of a transmission-type hologram cannot be prevented.

There is proposed a hologram recording medium having between a recording layer and a reflection layer a filter layer transmitting light of a first wavelength (e.g., red light) and reflecting light of a second wavelength (e.g., blue light or green light) (Japanese Patent Application No.2004-265472). In this layer structure, writing light transmitted through the recording layer cannot be prevented from being incident on the recording layer again. Thus, for example, when the light of the second wavelength is the writing light, the writing light is reflected on the filter layer and is incident on the recording layer again.

### SUMMARY OF THE INVENTION

The present invention has been made in view of the above circumstances and provides a method for preventing lowering of the diffraction efficiency due to writing of an unnecessary diffraction grating in a hologram recording medium having a reflection layer.

To achieve the above object, a hologram recording medium of a first aspect of the invention has a recording layer on which a hologram can be record as a diffraction grating by inducing a change in a refraction factor according to the light intensity distribution of writing light due to irradiation with the writing light; a reflection layer that reflects, on the recording layer side thereof, diffracted light diffracted by the hologram recorded on the recording layer due to irradiation with reading light having a wavelength different from that of the writing light; and an absorption layer that absorbs the writing light transmitted through the recording layer.

When a hologram is recorded, the recording layer of the hologram recording medium is irradiated with the writing light. The writing light transmitted through the recording layer is absorbed by the absorption layer and is not reflected on the recording layer side thereof, and thus, writing of an unnecessary diffraction grating caused by reflection of the writing light is prevented. As a result, lowering of the diffraction efficiency due to writing of the unnecessary diffraction grating can be prevented.

When the hologram is reproduced, the recording layer of the hologram recording medium is irradiated with the reading light having a wavelength different from that of the writing light. The diffracted light diffracted by the hologram recorded onto the recording layer is reflected toward the recording layer side by the reflection layer. As a result, the signal light can be reproduced at a high S/N ratio.

As described above, according to the invention, lowering of the diffraction efficiency due to writing of an unnecessary diffraction grating can be prevented, and a signal light cab en reproduced at a high S/N ratio, in a hologram recording medium having a reflection layer.

### BRIEF DESCRIPTION OF THE DRAWINGS

Preferred embodiments of the present invention will be described in detail based on the following figures, wherein:

FIG. 1 is a plan view of a hologram card according to a first embodiment of the invention.

FIG. 2 is a partial sectional view of the hologram card shown in FIG. 1.

FIG. 3 is a cross-sectional view showing another layer structure of a hologram memory.

FIG. 4 is a partial sectional view of a hologram card according to a second embodiment of the invention.

### DETAILED DESCRIPTION OF THE INVENTION

An embodiment of the present invention will be described below in detail with reference to the drawings.

### First Embodiment

[Hologram Card]

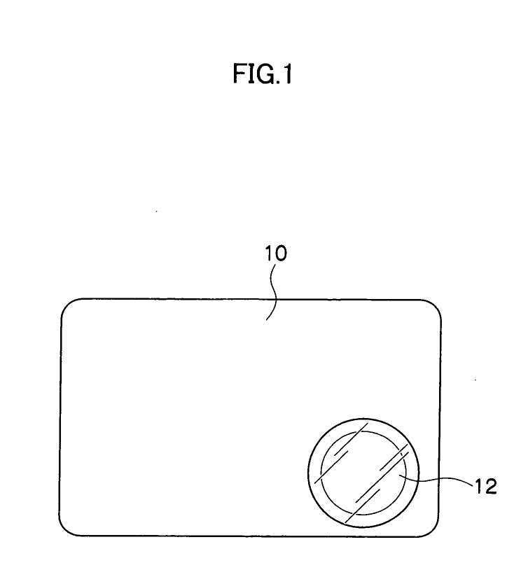

FIG. 1 is a plan view of a hologram card according to the present embodiment. This hologram card has a substrate 10 such as a plastic card, and a hologram memory 12 stuck on the substrate 10. A hologram can be recorded onto the hologram memory 12. That is, when recording has not been carried out on the hologram memory 12, on-demand information can be instantly imparted to unrecorded areas by a hologram.

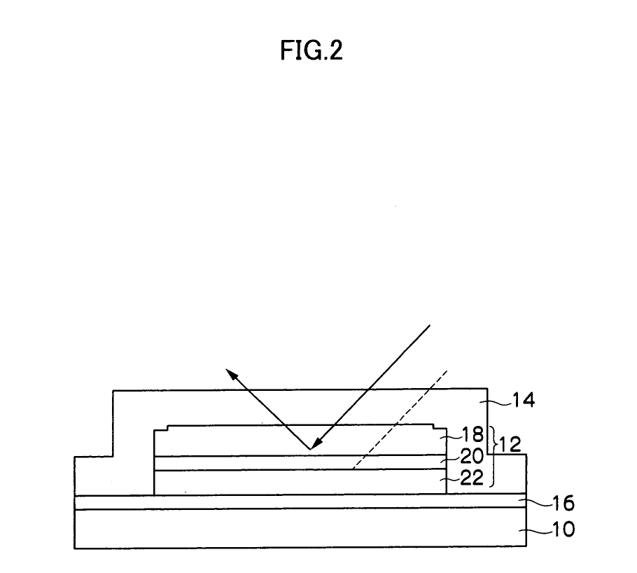

FIG. 2 is a partial sectional view of the hologram card shown in FIG. 1. The hologram memory 12 has its bottom fixed on the substrate 10 by an adhesive layer 16 and is stuck on the substrate 10. The substrate 10 and a protection layer 14 are adhered to each other by the adhesive layer 16 so as to interpose the hologram memory 12 therebetween. The hologram memory 12 is covered by the protection layer 14. A double-faced tape having adhesiveness is used as the adhesive layer 16.

The hologram memory 12 has a recording layer 18 onto which a hologram is recorded, and a selective reflection layer 20 that reflects, on the recording layer 18 side thereof, reference light (reading light) for irradiation at the time of reproduction of the hologram and transmits signal light and reference light (writing light) for irradiation at the time of recording of the hologram. An absorption layer 22 that absorbs light transmitted through the selective reflection layer 20 is formed on the light transmission side of the selective reflection layer 20.

By the provision of the selective reflection layer 20 and the absorption layer 22, the writing light transmitted through the recording layer 18 at the time of recording of the hologram is not reflected on the selective reflection layer 20 and is transmitted through the selective reflection layer 20 to be absorbed by the absorption layer 22. Therefore, writing of an unnecessary diffraction grating caused by reflection of the writing light is prevented. Upon irradiation with the reading light at the time of reproduction of the hologram, diffracted light diffracted by the hologram recorded on the recording layer 18 is reflected toward the recording layer 18 side.

As long as the substrate 10 has a flat surface, various materials may be arbitrarily selected to be used. For instance, metal, ceramics, resin, and paper can be used. The shape of the substrate 10 is not particularly limited. Glass, aluminum, metal such SUS, and a plastic material can be used, and these may be used together as desired. In the invention, a plastic material is preferably used in view of workability and versatility. In particular, a plastic material used as a card substrate such as a cash card or a commercially available card substrate is preferably used.

As the plastic material, a known plastic film can be used. Typical examples of the card substrate include a vinyl chloride resin and various polyester resins such as PET (polyethylene terephthalate) (for instance, a biaxially oriented PET resin, an amorphous polyester resin that is a non-biaxially-oriented PET and is called A-PET, and a modified PET resin called PETG in which about half of an ethylene glycol constituent used for PET synthesizing is replaced with a 1,4-cyclohexane methanol constituent).

Examples thereof include an ABS (acrylonitrile-butadiene-styrene) resin, a polyolefin resin, and resins such as polyacetate, cellulose triacetate, nylon, polycarbonate, polystyrene, polyphenylene sulfide, polypropylene, polyimide, and cellophane.

The recording layer 18 of the hologram memory 12 is not particularly limited and may be any recording layer on which a hologram can be written. As a material constructing the recording layer, an inorganic or organic hologram recording material can be used. Examples of the inorganic material include inorganic ferroelectric crystals such as barium titanate, lithium niobate, and bismuth silicate. In the invention, particularly, the organic hologram material is preferably used since productivity and flexibility of the hologram recording medium can be provided, and no external electric field is necessary when a refraction factor is changed. The layer structure of the invention is particularly useful when a material having a large volumetric shrinkage percentage of 1% or more is used as the recording layer.

As the organic hologram recording material, a photopolymer or an azopolymer can be used. To improve security, basically, the photopolymer in which a reaction by light irradiation is irreversible and writing is permitted only once is particularly preferable. Utilization of the photopolymer makes it impossible to rewrite the hologram so that card forgery is difficult.

As the photopolymer, it is possible to use a known material whose refraction factor or transmittance is changed due to a chemical change in a light irradiated portion. There are a positive photopolymer which can be dissolved by light irradiation and a negative photopolymer in which a light irradiated portion is cured. In the invention, the negative photopolymer is more preferably used. As described in “PHOTOPOLYMER NO KISO TO OHYO” (Fundamentals and Application of Photopolymers) by Ao Yamaoka (CMC Publishing Co., Ltd.), examples of the positive photopolymer include a material whose functional group is changed by light irradiation and a material whose molecular weight is lowered. Examples of the negative photopolymer include a material in which a reactive monomer is polymerized by light irradiation, a material polymerized by a generated radical, a material polymerized (shrunk) by a generated acid, a material whose constituent is diffused and moved between a polymerized portion and a non-polymerized portion, and a material that is cross-linked by light irradiation.

As the photopolymer, it is possible to use a photopolymer film formed in a film in advance (trade name: OmniDex (R), manufactured by DuPont), a volume hologram photosensitive material (manufactured by Nippon Paint Co., Ltd.), and transmission and reflection photopolymers (manufactured by Daiso Co., Ltd.).

The azopolymer is a high polymer including an azoic group subject to cis-trans isomerization by light irradiation and can record/reproduce a hologram using a change in a refraction factor. As the azopolymer, it is possible to use a known material, preferably including an azobenzene skeleton (a structure in which benzene rings are provided at both ends of an azoic group). With such a high polymer material, various molecular design can be carried out by dividing a main chain structure and a side chain structure. Various physical properties necessary for hologram recording such as a sensitive wavelength range, a response speed, and recording preservability as well as an absorption coefficient can be easily adjusted to a desired value at a high level. An example of such an azopolymer includes polyester having cyanoazobenzene on a side chain (see JP-A No. 10-340479).

The recording layer 18 is formed by coating the above material on the selective reflection layer 20 to have a desired thickness. When a plane hologram (a film thickness L of the recording layer is smaller than or about the same as the pitch of interference fringes recorded onto the recording layer) is recorded, the thickness of the recording layer 18 is preferably in the range of 3 to 100 μm and is more preferably in the range of 5 to 40 μm. When a volume hologram (the film thickness L of the recording layer is about the same as or several times larger than the pitch of interference fringes recorded onto the recording layer) is recorded, the thickness of the recording layer 18 is preferably in the range of 100 μm to 2 mm and is more preferably in the range of 250 μm to 1 mm.

The selective reflection layer 20 functions as a wavelength filter that transmits writing light having a predetermined wavelength and selectively reflects reading light having a wavelength different from that of the writing light. Examples of such a wavelength filter include an interference filter using interference and a filter using diffraction. As the interference filter, a band pass filter or a dichroic mirror performing color separation by reflected light and transmitted light can be used. When circularly polarized light is used as the writing light, the selective reflection layer 20 can be constructed using a cholesteric liquid crystal. The cholesteric liquid crystal has a property of selective reflection in which circularly polarized light having a wavelength equal to a spiral pitch and an orientation in the same direction as the winding of the spiral is reflected.

The selective reflection layer 20 is formed by being pressure bonded onto the photopolymer. Generally, the thickness of the selective reflection layer 20 is preferably in the range of 10 to 300 nm and is more preferably in the range of 50 to 200 nm.

An antireflection film is preferably interposed between the recording layer 18 and the selective reflection layer 20. Before the recording layer 18 is formed on the selective reflection layer 20, an AR coat is applied to the surface of the selective reflection layer 20 to provide the antireflection layer. The provision of the antireflection layer can prevent reflection of the writing light on the surface of the selective reflection layer 20, and thus, writing of an unnecessary grating due to the reflected light can be further prevented.

The absorption layer 22 absorbs the writing light transmitted through the selective reflection layer 20. As the absorption layer 22, a wavelength filter absorbing at least light having a wavelength of the writing light can be used. Examples of such a wavelength filter include a color filter containing a color material absorbing light having a wavelength of the writing light, and a compound semiconductor of copper, indium, or selenium such as Cu₂ZnSnS₄ (CZTS) or CuInS₂ which have been studied as materials of a light absorption layer of a solar battery. As the absorption layer 22, a light absorber in which there is hardly any wavelength dependence of a light absorptivity, including a metallic thin film such as inconel, chrome, or nickel can be used.

The absorption layer 22 is formed on the selective reflection layer 20 by pressure bonding or adhesion by an optical adhesive. Preferably, the thickness of the absorption layer 22 is suitably adjusted so that OD (optical density) is 0.5 or more. At OD of 0.5 or more, the light can be sufficiently absorbed.

The protection layer 14 is provided for protecting the hologram memory 12. The protection layer 14 may be a layer having a material and a thickness such that the hologram memory 12 is protected mechanically, physically, and chemically in a normal use environment. A known material can be used as the protection layer 14. Examples of the material of the protection layer 14 generally include a transparent resin material and a transparent inorganic material such as SiO₂. Here, the term “transparent” means that transmittance is high with respect to a light used for recording and reproduction.

A film-like resin material is preferably used as the protection layer 14 in view of workability. As a transparent and flexible resin film, tetraacetyl cellulose (TAC), polyethylene terephthalate (PET), polycarbonate (PC), polyimide (PI), polyether imide (PEI), polyether sulfone (PES), polysulfone (PSF), and polyallylate (PAR) can be used. The thickness of the resin film is not particularly limited as long as it can protect the recording layer, but for practical use, is preferably in the range of 3 to 200 μm, and more preferably in the range of 30 to 150 μm.

In this embodiment, there is described an example in which the substrate 10 and the protection layer 14 made of a resin film are adhered by the adhesive layer 16. However, instead of adhesion of the resin film, a thermoplastic resin, a thermosetting resin, or a photocuring resin may be coated so as to cover the hologram memory 12 to form the protection layer 14.

Examples of a transparent inorganic material used as the protection layer 14 include transparent ceramic materials such as SiO₂, MgF₂, SnO₂, and Si₃N₄ and glass material. The protection layer made of these inorganic materials can be formed using a sputtering method or a sol-gel method. The thickness of the transparent inorganic material formed as the protection layer is not particularly limited as long as it can protect the recording layer, but for practical use, is preferably in the range of 0.1 to 100 μm and more preferably in the range of 1 to 20 μm.

For irradiation with the writing light or the reading light via the protection layer 14 and extraction of the diffracted light via the protection layer 14, an excellent optical characteristic is required for the protection layer 14. The transmittance of the protection layer 14 wit respect to the writing light and the reading light is preferably 80% or more and more preferably 85% or more. The haze of the protection layer 14 is preferably 5% or less and more preferably 3% or less. When the transmittance and haze satisfy the above conditions, a high S/N ratio can be obtained.

The transmittance is a value measured using a haze meter (trade name: REFLECTANCE-TRANSMITTANCE METER, manufactured by Murakami Color Research Laboratory Co., Ltd.) in conformance with JISK 7361-1. Ahaze value is a value which expresses as a percentage (%) a result obtained by dividing a diffuse transmittance by a total light transmittance (diffuse transmittance/total light transmittance×100) and can be measured by the haze meter. The haze value is an index of transparency. As the haze value becomes smaller, the transparency becomes more excellent.

An antireflection (AR) coat may be applied to the surface of the protection layer 14.

[Hologram Card Manufacturing Method]

The above hologram is manufactured in such a manner that the adhesive layer 16 is provided on the substrate 10, and the hologram memory 12 is stuck on the substrate 10 together with a resin film as the protection layer 14 by the adhesive layer 16. The adhesive layer 16 is provided on the substrate 10 by sticking a double-faced tape having adhesiveness. The hologram memory 12 can be manufactured in such a manner that a dichroic mirror as the selective reflection layer 20 is prepared, a hologram recording material is coated on the surface of the dichroic mirror to form the recording layer 18, and a metallic thin film or a semiconductor thin film as the absorption layer 22 is formed on the back surface of the dichroic mirror.

[Hologram Recording and Reproduction]

When a hologram is recorded, the recording layer 18 of the hologram memory 12 is irradiated with a signal light and a reference light from the protection layer 14 side. The signal light and the reference light are emitted as the writing light. As a result, a transmission-type hologram is recorded onto the recording layer 18. As indicated by the dashed line in FIG. 2, the writing light after hologram recording is transmitted through the recording layer 18, and then emerges at the selective reflection layer 20 side. The selective reflection layer 20 does not reflect the writing light and transmits it. The writing light transmitted through the selective reflection layer 20 is absorbed by the absorbing layer 22. The writing light transmitted through the recording layer 18 is not reflected and is not incident on the recording layer 18 again, and no interference occurs between the reflected light and the writing light. Thus, writing of an unnecessary reflection-type hologram is prevented. No interference occurs between the reflected lights. Writing of the unnecessary transmission-type hologram is prevented.

When the hologram is reproduced, the recording layer 18 is irradiated with the reference light from the protection layer 14 side. The reference light is emitted as the reading light. The wavelength of the reading light is different from that of the reference light used at the time of recording. As the reading light, light having a wavelength longer than that of the reference light used at the time of recording is preferable. As indicated by the solid line in FIG. 2, when the hologram is reproduced, the reference light is diffracted by the transmission-type hologram recorded on the recording layer 18. The diffracted light is reflected on the selective reflection layer 20, transmitted through the recording layer 18 and the protection layer 14, and then emerges at the outside. As a result, the wavelength of the diffracted light is the same as that of the reading light. The signal light recorded as the hologram is reproduced.

As described above, according to this embodiment, the transmission-type hologram is recorded onto and reproduced from the recording layer of the hologram memory having the reflection layer. The reflection layer is a selective reflection layer that reflects the reading light and transmits the writing light without reflecting it. The absorption layer is provided at the light transmission side of the selective reflection layer. The writing light transmitted through the recording layer is absorbed so as to cause no reflected light, and thus, writing of an unnecessary diffraction grating due to reflection of the writing light is prevented. As a result, the signal light can be reproduced at a high S/N ratio. Further, the dynamic range is improved.

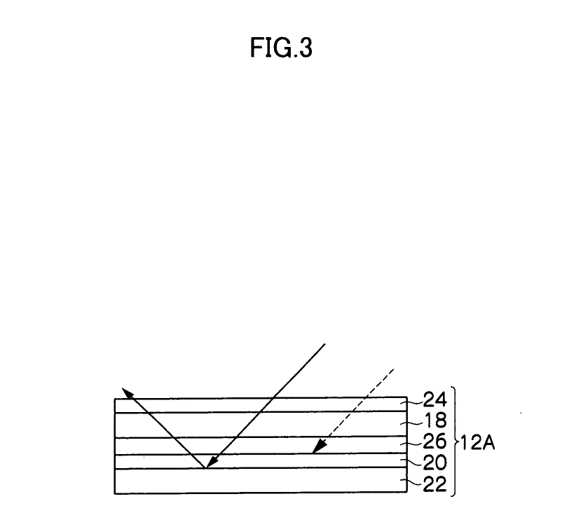

Circularly polarized light can be used as the writing light. By using the circularly polarized light as the writing light, no interference between the reflected light and the writing light occurs in principle and recording of an unnecessary diffraction grating due to a slight reflected light can be prevented. Thus, the S/N ratio is further increased. In this case, the writing light may be any light that is circularly polarized light when it is incident on the recording layer. As shown in FIG. 3, a quarter wave plate may be added to the recording medium side.

As shown in FIG. 3, a quarter wave plate 24 that converts linearly polarized light to circularly polarized light and converts the circularly polarized light to the linearly polarized light is provided on the recording layer 18 of a hologram memory 12A. An antireflection layer 26 formed by an AR coat is interposed between the recording layer 18 and the selective reflection layer 20. Other than the above-described structure, the structure of the hologram memory 12A is the same as the layer structure of the hologram memory 12 shown in FIG. 2. Therefore, the same reference numerals are used, and description of the identical structure is omitted.

The quarter wave plate 24 has a function in which linearly polarized light like p-polarized light or s-polarized light is incident, and when an angle of the direction of the linearly polarized light to the optical axis of a crystal of the quarter wave plate is 45°, the transmitted light is converted from the linearly polarized light to circularly polarized light. The quarter wave plate 24 can be constructed using a polarization sensitive material such as azobenzene. The molecules of the polarization sensitive material are arranged in the quarter wave plate along a concentric circle having the same center as that of a circular wave plate to cause a phase difference in the incident light. The thickness of the polarization sensitive material is preferably 1 to 10 μm.

When the quarter wave plate is added to the recording medium side, the quarter wave plate can protect the recording layer, and the protection layer can be omitted.

### Second Embodiment

[Hologram Card]

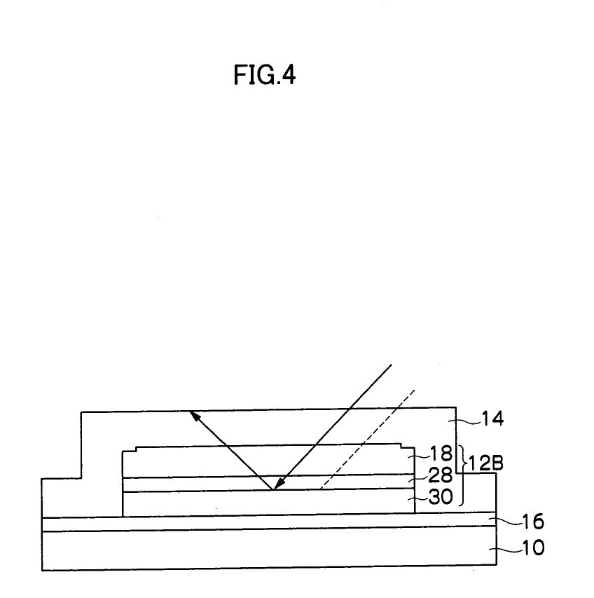

FIG. 4 is a cross-sectional view of a hologram card according to a second embodiment. Other than the layer structure of the hologram memory, the hologram card according to the second embodiment has the same construction as that of the hologram card shown in FIG. 2. Therefore, the same reference numerals are used, and the description of the identical structure is omitted.

A hologram memory 12B has the recording layer 18 onto which a hologram is recorded, and a selective absorption layer 28 that transmits a reference light (reading light) for irradiation at the time of reproduction of the hologram and absorbs a signal light and a reference light (writing light) for irradiation at the time of recording of the hologram. At the optical transmission side of the selective absorption layer 28, a reflection layer 30 that reflects the diffracted light transmitted through the selective absorption layer 28 is formed.

In this manner, by providing the selective absorption layer 28 and the reflection layer 30, the writing light transmitted through the recording layer 18 at the time of recording of the hologram is absorbed by the selective absorption layer 28 and does not reach the reflection layer 30. Accordingly, the writing light is not reflected on the reflection layer 30, and writing of an unnecessary diffraction grating due to reflection of the writing light is prevented. Upon irradiation with the reading light at the time of reproduction of the hologram, the diffracted light diffracted by the hologram recorded on the recording layer 18 is transmitted through the selective absorption layer 28 and is reflected toward the recording layer 18 side by the reflection layer 30.

The selective absorption layer 28 functions as a wavelength filter that selectively absorbs the writing light having a predetermined wavelength and transmits the reading light having a wavelength different from that of the writing light. As such a wavelength filter, a color filter containing a color material that absorbs light having a wavelength of the writing light, a high pass filter, a low pass filter, an edge filter, a dichroic filter, an interference filter, or a band pass filter can be used. Among these filters there are filters in which an absorbing intensity changes by several decimal places when a wavelength differs by only several tens of nanometers.

Preferably, the thickness of the selective absorption layer 28 is suitably adjusted so that OD (optical density) is 0.5 or more. At OD of 0.5 or more, the light is effectively absorbed.

The antireflection film is preferably interposed between the recording layer 18 and the selective absorption layer 28. Before the recording layer 18 is formed on the selective absorption layer 28, the antireflection film can be provided by applying an AR coat to the surface of the selective absorption layer 28. The provision of the antireflection film prevents reflection of the writing light on the surface of the selective absorption layer 28, and thus, writing of an unnecessary grating due to the reflected light is further prevented.

The reflection layer 30 reflects the diffracted light diffracted by the hologram at the time of reproduction of the hologram. The reflection layer 30 is preferably made of a light reflective material in which a reflectivity with respect to the reading light is 70% or more. Examples of such a light reflective material include metal such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi, semimetal, and stainless steel.

These light reflective materials may be used singly, or a combination of two or more or an alloy of these may be used. The preferable materials among these are Cr, Ni, Pt, Cu, Ag, Au, and Al and stainless steel. The particularly preferable materials are Au, Ag, Al, or an alloy of these. The most preferable materials are Au, Ag, or an alloy of these.

The reflection layer 30 is formed, for example, by depositing, sputtering or ion plating the light reflective material on the back surface of the selective absorption layer 28. The reflection layer 30 can be directly formed on the substrate 10. A reflection film formed with a reflection coat on a resin film can be used as the reflection layer 30. Generally, the layer thickness of the reflection layer 30 is preferably in the range of 10 to 300 nm and preferably in the range of 50 to 200 nm.

[Hologram Card Manufacturing Method]

The above hologram card is manufactured in such a manner that the adhesive layer 16 is provided on the substrate 10 and the hologram memory 12B is stuck on the substrate 10 together with a resin film as the protection layer 14 by the adhesive layer 16. The hologram memory 12B can be manufactured in such a manner that a band pass filter as the selective absorption layer 28 is prepared, a hologram recording material is coated onto the surface of the band pass filter to form the recording layer 18, and a metallic thin film is deposited on the back surface of the band pass filter to form the reflection layer 30.

[Hologram Recording and Reproduction]

When a hologram is recorded, the recording layer 18 of the hologram memory 12B is irradiated with the signal light and the reference light from the protection layer 14 side. The signal light and the reference light are emitted as the writing light. As a result, a transmission-type hologram is recorded on the recording layer 18. As indicated by the dashed line in FIG. 4, when the hologram is recorded, the writing light is transmitted through the recording layer 18 to be incident on the selective absorption layer 28. The selective absorption layer 28 absorbs the writing light without transmitting it, and thus, the writing light transmitted through the recording layer 18 does not reach the reflection layer 30. Accordingly, writing of an unnecessary diffraction grating due to reflection of the writing light is prevented.

When the hologram is reproduced, the recording layer 18 is irradiated with the reference light from the protection layer 14 side. The reference light is emitted as the reading light. The wavelength of the reading light is different from that of the reference light used at the time of recording. As the reading light, light having a wavelength longer than that of the reference light used at the time of recording is preferable. As indicated by the solid line in FIG. 4, when the hologram is reproduced, the reference light is diffracted by the transmission-type hologram recorded on the recording layer 18. The diffracted light is transmitted through the selective absorption layer 28 and reflected on the reflection layer 30. The reflected diffracted light is transmitted through the selective absorption layer 28, the recording layer 18, and the protection layer 14 and then emerges at the outside. The wavelength of the diffracted light is the same as that of the reading light. As a result, the signal light recorded as the hologram is reproduced.

As described above, according to this embodiment, the transmission-type hologram is recorded onto and reproduced from the recording layer of the hologram memory having the reflection layer. The selective absorption layer that transmits the reading light and absorbs the writing light without transmitting it is provided between the reflection layer and the recording layer. The writing light transmitted through the recording layer is absorbed so as to cause no reflected light, and thus, writing of an unnecessary diffraction grating due to reflection of the writing light is prevented. As a result, the signal light can be reproduced at a high S/N ratio. Further, the dynamic range is improved.

As in the first embodiment, circular polarized light can be used as the writing light. Further, as in the first embodiment, a quarter wave plate can be added to the recording medium side.

### EXAMPLES

The invention will be described below more specifically with examples but is not limited to these examples.

### Example 1

A commercially available dichroic mirror (trade name: GREEN TRANSMISSION FILTER, manufactured by Optical Coatings Japan) having a size of 20 mm×20 mm and a thickness of 0.3 mm is prepared. The dichroic mirror has a characteristic of transmitting light having a wavelength of 532 nm and reflecting light having a different wavelength and functions as a selective reflection layer. Carbon is deposited on the back surface of the dichroic mirror to form an absorption layer having an OD of 4. The carbon constructing the absorption layer has a characteristic in which there is hardly any wavelength dependence of light absorption. Thereafter, a photopolymer (trade name: OmniDex (R), manufactured by DuPont) is pressure bonded onto the surface of the dichroic mirror to form a recording layer having a thickness of 20 μm. A sheet-like hologram memory having the recording layer, the selective reflection layer, and the absorption layer is obtained.

The obtained hologram memory is placed on a protection film having an area which is larger than the hologram memory (trade name: ZEONOR (R), manufactured by Zeon Corporation) so that the recording layer and the protection film are contacted with each other. The protection film is stuck on the surface of a commercially available plastic card using a double-faced adhesive tape (trade name: 5605, manufactured by Nitto Denko Corporation) so as to interpose the hologram memory between the card and the film, whereby the hologram memory is fixed on the plastic card. As a result, the hologram card according to Example 1 is obtained.

An image hologram is recorded on the obtained hologram card using signal light and reference light having a wavelength of 532 nm. A laser beam having a wavelength of 633 nm is used as the reading light on the recording layer of the hologram memory, and the recorded hologram is reproduced at a high S/N ratio. The diffraction efficiency at the time of reproduction is 96%.

### Example 2

A commercially available color filter (trade name: MAGENTA FILTER, manufactured by Fuji Photo Film Co., Ltd.) having a size of 20 mm×20 mm and a thickness of 90 μm is prepared. The color filter has a characteristic of absorbing light having a wavelength of 532 nm and transmitting light having a different wavelength and functions as the selective absorption layer. Aluminum is deposited on the back surface of the color filter to form a reflection layer having a thickness of 0.1 μm. A photopolymer (trade name: OPTREM (R), manufactured by Nippon Paint Co., Ltd.) is cast on the surface of the color filter to form a recording layer having a thickness of 20 μm. As a result, a sheet-like hologram memory having the recording layer, the selective absorption layer, and the reflection layer is obtained.

The obtained hologram memory is placed on a protection film having an area larger than the hologram memory (trade name: ZEONOR (R), manufactured by Zeon Corporation) so that the recording layer and the protection film are contacted with each other. The protection film is stuck on the surface of a commercially available plastic card using a double-faced adhesive tape (trade name: 5605, manufactured by Nitto Denko Corporation) so as to interpose the hologram memory between the card and the film, whereby the hologram memory is fixed on the plastic card. As a result, the hologram card according to Example 2 is obtained.

A binary image is recorded as a Fourier transformed hologram onto the obtained hologram card using signal light and reference light having a wavelength of 532 nm. A brightness histogram of monochrome data is obtained from a reproduced image using a laser beam having a wavelength of 633 nm as the reading light. An SNR (signal-to-noise ratio) is determined from the following equation, and the SNR value is found to be 4.5. The hologram is multi-recorded onto this medium five times, and the dynamic range value calculated from each diffraction efficiency is 0.9.
SNR=(μ_{w}−μ_{b})/(σ_{w}²−σ_{b}²)^{1/2}
Here, μ_{w} and μ_{b} express average brightness of a white pixel distribution and a black pixel distribution, respectively, and σ_{w} and σ_{b} express dispersions of the respective distributions.

### Comparative Example 1

Comparative Example 1 is carried out in the same manner as Example 2 except that the selective absorption layer is replaced with a transparent film layer, whereby a hologram card according to Comparative Example 1 is obtained. The transparent film layer transmits light having a wavelength in the range of 280 to 800 nm including light having a wavelength of 532 nm.

A Fourier transformed hologram of a binary image is recorded onto the obtained hologram card using the signal light and the reference light having a wavelength of 532 nm. A brightness histogram of monochrome data is obtained from a reproduced image using a laser beam having a wavelength of 633 nm as the reading light on the recording layer of the hologram memory. An SNR is determined from the above equation, and the SNR value is found to be 1.1. The hologram is multi-recorded onto this medium five times, and the dynamic range value calculated from each diffraction efficiency is 0.3.

From the above results, when the hologram recording medium is not provided with a layer structure for preventing reflection of the writing light (Comparative Example 1), the SNR is significantly lowered and the dynamic range is at a level which is about one-third of that of the hologram recording medium having the selective absorption layer (Example 2). In the hologram recording medium with the layer structure having the selective reflection layer and the absorption layer, the diffraction efficiency is high, and usability thereof is confirmed (Example 1). These effects are thought to be obtained because writing of an unnecessary diffraction grating due to reflection of the writing light is prevented and waste of the dynamic range is avoided.

What is claimed is:

1. A hologram recording medium comprising:
a recording layer on which a hologram can be record as a diffraction grating by inducing a change in a refraction factor according to the light intensity distribution of writing light due to irradiation with the writing light;
a reflection layer that reflects, on the recording layer side thereof, diffracted light diffracted by the hologram recorded on the recording layer due to irradiation with reading light having a wavelength different from that of the writing light; and
an absorption layer that absorbs the writing light transmitted through the recording layer.

2. A hologram recording medium comprising:
a recording layer on which a hologram can be recorded as a diffraction grating by inducing a change in a refraction factor according to the light intensity distribution of writing light due to irradiation with the writing light;
a selective reflection layer that transmits the writing light transmitted through the recording layer and reflects, on the recording layer side thereof, diffracted light diffracted by the hologram recorded on the recording layer due to irradiation with a reading light having a wavelength different from that of the writing light; and
an absorption layer that is provided on the reflection layer at a side opposite from the recording layer and absorbs the writing light transmitted through the selective reflection layer.

3. The hologram recording medium of claim 2, wherein the selective reflection layer comprises a wavelength filter transmitting light having a wavelength of the writing light and reflecting light having a wavelength of the reading light.

4. The hologram recording medium of claim 3, wherein the wavelength filter is an interference filter using interference.

5. The hologram recording medium of claim 4, wherein the interference filter is a band pass filter or a dichroic mirror.

6. The hologram recording medium of claim 2, wherein when a circularly polarized light is used as the writing light, a cholesteric liquid crystal is used as the selective reflection layer.

7. The hologram recording medium of claim 2, wherein the absorption layer comprises a wavelength filter absorbing at least light having a wavelength of the writing light.

8. The hologram recording medium of claim 7, wherein the wavelength filter is a color filter containing a color material that absorbs light having a wavelength of the writing light.

9. The hologram recording medium of claim 2, wherein the absorption layer comprises a compound semiconductor containing copper, indium, and selenium.

10. The hologram recording medium of claim 2, wherein the absorption layer comprises a metallic thin film absorbing at least light having a wavelength of the writing light.

11. The hologram recording medium of claim 2, wherein the optical density of the absorption layer is 0.5 or more.

12. A hologram recording medium comprising:
a recording layer on which a hologram can be recorded as a diffraction grating by inducing a change in a refraction factor according to the light intensity distribution of writing light due to irradiation with the writing light;
a reflection layer that reflects, on the recording layer side thereof, a diffracted light diffracted by the hologram recorded on the recording layer due to irradiation with reading light having a wavelength different from that of the writing light; and
a selective absorption layer that is provided between the recording layer and the reflection layer, transmits the diffracted light, and absorbs the writing light transmitted through the recording layer.

13. The hologram recording medium of claim 12, wherein the selective absorption layer comprises a wavelength filter that absorbs light having a wavelength of the writing light and transmits light having a wavelength of the reading light.

14. The hologram recording medium of claim 13, wherein the wavelength filter is a color filter containing a color material that absorbs light having a wavelength of the writing light.

15. The hologram recording medium of claim 13, wherein the wavelength filter is selected from the group consisting of a high pass filter, a low pass filter, an edge filter, a dichroic mirror, an interference filter, and a band pass filter.

16. The hologram recording medium of claim 12, wherein the optical density of the absorption layer is 0.5 or more.

17. The hologram recording medium of claim 12, wherein the reflection layer comprises a light reflective material whose reflectivity to the reading light is 70% or more.

18. The hologram recording medium of claim 1, wherein the recording layer comprises a photopolymer whose refraction factor or transmittance is changed by a chemical change in a portion irradiated with the writing light.

19. The hologram recording medium of claim 2, wherein the recording layer comprises a photopolymer whose refraction factor or transmittance is changed by a chemical change in a portion irradiated with the writing light.

20. The hologram recording medium of claim 12, wherein the recording layer comprises a photopolymer whose refraction factor or transmittance is changed by a chemical change in a portion irradiated with the writing light.

21. The hologram recording medium of claim 1, further comprising a substrate, the recording layer, the reflection layer, and the absorption layer being laminated on the substrate so that the recording layer is an uppermost layer.

22. The hologram recording medium of claim 2, further comprising a substrate, the recording layer, the reflection layer, and the absorption layer being laminated on the substrate so that the recording layer is an uppermost layer.

23. The hologram recording medium of claim 12, further comprising a substrate, the recording layer, the reflection layer, and the absorption layer being laminated on the substrate so that the recording layer is an uppermost layer.

24. The hologram recording medium of claim 1, further comprising a protection layer protecting the recording layer.

25. The hologram recording medium of claim 2, further comprising a protection layer protecting the recording layer.

26. The hologram recording medium of claim 12, further comprising a protection layer protecting the recording layer.

27. The hologram recording medium of claim 1, further comprising an antireflection film provided on the surface at the recording layer side of the reflection layer.

28. The hologram recording medium of claim 2, further comprising an antireflection film provided on the surface at the recording layer side of the reflection layer.

29. The hologram recording medium of claim 12, further comprising an antireflection film provided on the surface at the recording layer side of the reflection layer.

30. The hologram recording medium of claim 1, further comprising an antireflection film provided on the surface at the recording layer side of the absorption layer.

31. The hologram recording medium of claim 2, further comprising an antireflection film provided on the surface at the recording layer side of the absorption layer.

32. The hologram recording medium of claim 12, further comprising an antireflection film provided on the surface at the recording layer side of the absorption layer.

33. The hologram recording medium of claim 24, further comprising an antireflection film provided on the surface of the protection layer.

34. The hologram recording medium of claim 25, further comprising an antireflection film provided on the surface of the protection layer.

35. The hologram recording medium of claim 26, further comprising an antireflection film provided on the surface of the protection layer.

36. The hologram recording medium of claim 1, further comprising a quarter wave plate provided on the surface of the recording layer.

37. The hologram recording medium of claim 2, further comprising a quarter wave plate provided on the surface of the recording layer.

38. The hologram recording medium of claim 12, further comprising a quarter wave plate provided on the surface of the recording layer.

39. The hologram recording medium of claim 24, further comprising a quarter wave plate provided on the surface of the protection layer.

40. The hologram recording medium of claim 25, further comprising a quarter wave plate provided on the surface of the protection layer.

41. The hologram recording medium of claim 26, further comprising a quarter wave plate provided on the surface of the protection layer.

42. A hologram recording method of recording a hologram by irradiating a recording layer, on which a hologram can be recorded, with writing light while the writing light transmitted through the recording layer is absorbed.

43. A hologram recording method of recording a hologram on a hologram recording medium, the hologram recording medium comprising:
a recording layer on which a hologram can be recorded as a diffraction grating by inducing a change in a refraction factor according to the light intensity distribution of writing light due to irradiation with the writing light;
a reflection layer that reflects, on the recording layer side thereof, diffracted light diffracted by the hologram recorded on the recording layer due to irradiation with reading light having a wavelength different from that of the writing light; and
an absorption layer that absorbs the writing light transmitted through the recording layer,
wherein the hologram is recorded by irradiating the recording layer with the writing light while the writing light transmitted through the recording layer is absorbed by the absorption layer so as to prevent the writing light from being reflected on the reflection layer.

44. A hologram recording method of recording a hologram on a hologram recording medium, the hologram recording medium comprising:
a recording layer on which a hologram can be recorded as a diffraction grating by inducing a change in a refraction factor according to the light intensity distribution of writing light due to irradiation with the writing light;
a selective reflection layer that transmits the writing light transmitted through the recording layer and reflects, on the recording layer side thereof, diffracted light diffracted by the hologram recorded on the recording layer due to irradiation with a reading light having a wavelength different from that of the writing light; and
an absorption layer that is provided on the reflection layer at a side opposite from the recording layer and absorbs the writing light transmitted through the selective reflection layer,
wherein the hologram is recorded by irradiating the recording layer with the writing light while the writing light transmitted through the recording layer is absorbed by the absorption layer so as to prevent the writing light from being reflected on the reflection layer.

45. A hologram recording method of recording a hologram on a hologram recording medium, the hologram recording medium comprising:
a recording layer on which a hologram can be recorded as a diffraction grating by inducing a change in a refraction factor according to the light intensity distribution of writing light due to irradiation with the writing light;
a reflection layer that reflects, on the recording layer side thereof, diffracted light diffracted by the hologram recorded on the recording layer due to irradiation with reading light having a wavelength different from that of the writing light; and
a selective absorption layer that is provided between the recording layer and the reflection layer, transmits the diffracted light, and absorbs the writing light transmitted through the recording layer,
wherein the hologram is recorded by irradiating the recording layer with the writing light while the writing light transmitted through the recording layer is absorbed by the absorption layer so as to prevent the writing light from being reflected on the reflection layer.

46. The hologram recording method of claim 43, wherein circular polarized light is used as the writing light.

47. The hologram recording method of claim 44, wherein circular polarized light is used as the writing light.

48. The hologram recording method of claim 45, wherein circular polarized light is used as the writing light.
